(19) United States
(12) Patent Application Publication
(10) Pub. No.: US 2006/0135400 A1
(43) Pub. Date: Jun. 22, 2006

(54) 4-Cyclohexyl-2-butanol as an odiferous substance

(76) Inventors: Walter Kuhn, Holzminden (DE); Karl-Heinz Bork, Deensen (DE); Horst Surburg, Holzminden (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/546,557

(22) PCT Filed: Feb. 12, 2004
(86) PCT No.: PCT/EP04/01282

§ 371 Date: Aug. 23, 2005

(51) Int. Cl. A61Q 13/00

(52) U.S. Cl. 512/24

(57) ABSTRACT

The use of 4-cyclohexyl-2-butanol as a fragrance substance and in particular as a lily of the valley fragrance substance is described. Blends of fragrance substances and perfumed products, each containing 4-cyclohexyl-2-butanol, are also described, as well as a process for producing a corresponding perfumed product.

The invention primarily concerns the use of 4-cyclohexyl-2-butanol as a fragrance substance and in particular as a lily of the valley fragrance substance. The invention also concerns blends of fragrance substances and perfumed products, each containing 4-cyclohexyl-2-butanol, as well as a process for producing a corresponding perfumed product.

Fragrance substances having a lily of the valley fragrance are widely used in perfumes, fragrance substance blends (perfume compositions) and perfuming products for diverse areas of application. Through their lily of the valley-like fragrance, lily of the valley fragrance substances impart a clean, clear, transparent freshness to fragrance substance compositions which is not achieved by other floral fragrance substances. In comparison to other fragrances, lily of the valley fragrance is most clearly associated with the feeling of freshness and cleanliness, and so among the floral fragrance substances lily of the valley fragrance substances are of particular interest. The effort devoted by the fragrance substances industry to establishing new fragrance substances having a lily of the valley fragrance is correspondingly high.

The search for suitable fragrance substances having a lily of the valley fragrance is made more difficult for the person skilled in the art, however, by the following facts in particular:
The mechanisms of fragrance perception are not adequately known.
An objective-quantitative characterisation of a fragrance is not yet possible at present.
The correlations between the special fragrance perception on the one hand and the chemical structure of the associated fragrance substance on the other have not been sufficiently researched.
Even minor changes to the structural make-up of a known fragrance substance frequently bring about major changes to the olfactory properties and interfere with the tolerance for the human organism.

The success of the search for suitable fragrance substances (in this case having a lily of the valley fragrance) is therefore highly dependent on the intuition of the person engaged in the search.

In commercial terms the most important lily of the valley fragrance substances are currently 3-(4t-butylphenyl)-2-methyl propanal (trade names e.g. Lilial, Lysmeral, Lilestralis), 3-7-dimethyl-7-hydroxyoctanal (trivial name hydroxycitronellal) and 4-(4-hydroxy-4-methylpentyl)-3-cyclohexene carboxaldehyde (trade names e.g. Kovanol, Lyral).

However, many people react to these substances with intolerances, such as with allergic reactions, for example. There is therefore a need for alternative fragrance substances having a lily of the valley fragrance, in particular ones which can replace the aforementioned compounds in perfume compositions and which display no such negative toxicological properties. It is a considerable advantage if these alternative products are as similar as possible to the fragrance substances to be replaced, both in their sensorial-olfactory and in their applicational properties.

It has now been found that 4-cyclohexyl-2-butanol is an excellent fragrance substance having a particularly natural and pure-toned lily of the valley fragrance which can replace the hitherto used (allergy-triggering) fragrance substances having a lily of the valley fragrance in perfume compositions.

This result is particularly surprising because known substances with structures similar to that of 4-cyclohexyl-2-butanol, some of which likewise display lily of the valley-like fragrance notes, cannot bring about the desired effect as fragrance substances. Such substances are, for example, 2-methyl-1-phenyl-2-propanol, 2-methyl-4-phenyl-2-butanol, 3-methyl-1-phenyl-3-pentanol, 5-phenyl-3-pentanol (e.g. Steffen Arctander, Perfume and Flavor Chemicals, self-published, Montclair, N.J., 1969; K. Bauer, D. Garbe, H. Surburg, Common Fragrance and Flavor Materials, 4^{th} Edition, Wiley-VCH, Weinheim 2001), 1-(4-isopropylcyclohexyl)ethanol (R. Pelzer et al. in R. Hopp and K. Mori, Recent Developments in Flavor and Fragrance Chemistry, VCH, Weinheim 1993, p. 29 ff.), 1-cyclohexyl-2-methyl-2-propanol (EP 1108703), 4-cyclohexyl-3-methyl-2-butanol (U.S. Pat. No. 5,372,995) and 4-cyclohexyl-2-methyl-2-butanol (EP 180885). None of these substances displays such a natural and pure-toned lily of the valley scent as the 4-cyclohexyl-2-butanol according to the invention. Specifically:
2-Methyl-1-phenyl-2-propanol has a herbal-floral fragrance, rather like lilac.
The fragrance of 2-methyl-4-phenyl-2-butanol is floral, but rather green and herbal, heading in the direction of hyacinths and lilies.
3-Methyl-1-phenyl-3-pentanol does have a secondary lily of the valley fragrance, but a rose note reminiscent of the fragrance of peonies is dominant.
5-Phenyl-3-pentanol has a floral, green fragrance which is only slightly reminiscent of lily of the valley.
1-(4-Isopropylcyclohexyl)ethanol does smell predominantly of lily of the valley, but because of a slightly spicy, green earthy, lilac-like note it displays not nearly such a pure-toned and characteristic lily of the valley fragrance as the 4-cyclohexyl-2-butanol according to the invention.
The fragrance of 1-cyclohexyl-2-methyl-2-propanol is described as fresh, floral, lilac-like and minty; this compound is therefore unsuitable as a lily of the valley fragrance substance.
4-Cyclohexyl-3-methyl-2-butanol and 4-cyclohexyl-2-methyl-2-butanol smell less of lily of the valley and more like linalool (3,7-dimethyl-1,6-octadien-3-ol) and dihydromyrcenol (2,6-dimethyl-7-octen-2-ol), which have a rather freshly floral, citrus-like fragrance character (Steffen Arctander, Perfume and Flavor Chemicals, self-published, Montclair, N.J., 1969) and whose lily of the valley note is much less pronounced than in the 4-cyclohexyl-2-butanol according to the invention.

4-Cyclohexyl-2-butanol is known as a chemical compound. However, in Beilsteins Handbuch der Organischen Chemie Vol. 6, 1^{st} Supplement, 4^{th} Edition 1931, p. 18, there is merely the mention that 4-cyclohexyl-2-butanol is a “liquid with a pleasant odour”. A more accurate description of the olfactory-sensorial properties is not provided. In particular, there is no mention that 4-cyclohexyl-2-butanol has a natural and pure-toned lily of the valley fragrance and is therefore suitable for use in place of the hitherto conventional substances as a lily of the valley fragrance substance in perfume compositions.

4-Cyclohexyl-2-butanol has a typical floral scent of lily of the valley with only a slight linalool-like note and with fresh and fruity aspects. On the basis of these sensorial-olfactory properties, 4-cyclohexyl-2-butanol is extremely suitable for use as a fragrance substance in perfume oil compositions which can be designed in particular for use in detergents and fabric softeners. Even in small doses, effects with a marked naturalness in the resulting compositions can be achieved with 4-cyclohexyl-2-butanol, the overall olfactory impression being intensified and harmonised all in all and the emanation and diffusibility being perceptibly increased. 4-Cyclohexyl-2-butanol can be used in fragrance compositions in particular to obtain a clear, clean, transparent and fresh fragrance note. As a component with a pronounced lily of the valley fragrance, 4-cyclohexyl-2-butanol is particularly suitable for completely or at least partly replacing fragrance substances such as 3-(4t-butylphenyl)-2-methyl propanal, 3,7-dimethyl-7-hydroxyoctanal and 4-(4-hydroxy-4-methylpentyl)-3-cyclohexene carboxaldehyde, which have negative toxicological properties, in perfume compositions.

4-Cyclohexyl-2-butanol can be used in many products; it can be used as a single fragrance substance, but it can particularly advantageously be combined with other fragrance substances in various, differing proportions to form fragrance substance blends, also allowing novel and original perfume compositions to be created.

Accordingly, one aspect of the invention also concerns a blend of two or more fragrance substances (fragrance substance blend) and optionally other constituents (solvents or similar), which includes 4-cyclohexyl-2-butanol. The fragrance substance blend advantageously contains 4-cyclohexyl-2-butanol in a quantity which
(a) modifies the olfactory properties of a blend of the other constituents of the fragrance substance blend to make it clearer, cleaner, more transparent and fresher and/or
(b) adds a lily of the valley note to the olfactory properties of a blend of the other constituents of the fragrance substance blend.

Examples of fragrance substances with which 4-cyclohexyl-2-butanol can advantageously be combined can be found for example in S. Arctander, Perfume and Flavor Materials, Vol. I and II, Montclair, N.J., 1969, self-published or K. Bauer, D. Garbe and H. Surburg, Common Fragrance and Flavor Materials, 4^{th} Edition, Wiley-VCH, Weinheim 2001.

The following can be cited specifically:

Extracts of Natural Raw Materials Such as Essential Oils, Concretes, Absolutes, Resins, Resinoids, Balsams, Tinctures, Such as for Example:

Ambergris tincture; amyris oil; angelica seed oil; angelica root oil; aniseed oil; valerian oil; basil oil; treemoss absolute; bay oil; mugwort oil; benzoin resin; bergamot oil; beeswax absolute; birch tar oil; bitter almond oil; savory oil; buchu leaf oil; cabreuva oil; cade oil; calamus oil; camphor oil; cananga oil; cardamom oil; cascarilla oil; cassia oil; cassie absolute; castoreum absolute; cedar leaf oil; cedarwood oil; cistus oil; citronella oil; citrus oil; copaiba balsam; copaiba balsam oil; coriander oil; costus root oil; cumin oil; cypress oil; davana oil; dill weed oil; dill seed oil; eau de brouts absolute; oakmoss absolute; elemi oil; tarragon oil; eucalyptus citriodora oil; eucalyptus oil; fennel oil; spruce needle oil; galbanum oil; galbanum resin; geranium oil; grapefruit oil; guaiac wood oil; gurjun balsam; gurjun balsam oil; helichrysum absolute; helichrysum oil; ginger oil; iris root absolute; iris root oil; jasmine absolute; calamus oil; camomile blue oil; camomile Roman oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemongrass oil; lovage oil; distilled lime oil; pressed lime oil; linaloe oil; litsea cubeba oil; bayleaf oil; mace oil; marjoram oil; mandarin oil; massoi bark oil; mimosa absolute; musk seed oil; musk tincture; clary sage oil; nutmeg oil; myrrh absolute; myrrh oil; myrtle oil; clove leaf oil; clove flower oil; neroli oil; olibanum absolute; olibanum oil; opopanax oil; orange flower absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil; spike lavender oil; star anise oil; styrax oil; tagetes oil; fir needle oil; tea-tree oil; turpentine oil; thyme oil; tolu balsam; tonka absolute; tuberose absolute; vanilla extract; violet leaf absolute; verbena oil; vetiver oil; juniper berry oil; cognac oil; wormwood oil; wintergreen oil; ylang-ylang oil; hyssop oil; civet absolute; cinnamon leaf oil; cinnamon bark oil and fractions thereof, or ingredients isolated therefrom;

Individual fragrance substances fragrances from the group

of hydrocarbons, such as, for example, 3-carene; a-pinene; b-pinene; a-terpinene; g-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;

of aliphatic alcohols, such as, for example, hexanol; octanol; 3-octanol; 2,6-dimethylheptanol; 2-methyl-2-heptanol, 2-methyl-2-octanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methylene heptan-2-ol; (E,Z)-2,6-nonadienol; 3,7-dimethyl-7-methoxyoctan-2-ol; 9-decenol; 10-undecenol; 4-methyl-3-decen-5-ol;

of aliphatic aldehydes and acetals thereof, such as, for example, hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethyl acetal; 1,1-dimethoxy-2,2,5-trimethyl-4-hexene; citronellyl oxyacetaldehyde; 1-(1-methoxypropoxy)-(E/Z)-3-hexene;

of aliphatic ketones and oximes thereof, such as, for example, 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;

of aliphatic sulfur-containing compounds, such as, for example, 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;

of aliphatic nitriles, such as, for example, 2-nonenenitrile; 2-undecenenitrile; 2-tridecenenitrile; 3,12-tridecadienenitrile; 3,7-dimethyl-2,6-octadienenitrile; 3,7-dimethyl-6-octenenitrile;

of esters of aliphatic carboxylic acids, such as, for example, (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl-2-methylpentanoate; ethyl hexanoate; allyl hexanoate; ethyl heptanoate; allyl heptanoate; ethyl octanoate; ethyl-(E,Z)-2,4-decadienoate; methyl-2-octynoate; methyl-2-nonynoate; allyl-2-isoamyloxyacetate; methyl-3,7-dimethyl-2,6-octadienoate; 4-methyl-2-pentyl crotonate;

of acyclic terpene alcohols, such as, for example, citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and formates, acetates, propionates, isobutyrates, butyrates, isovalerates, pentanoates, hexanoates, crotonates, tiglinates and 3-methyl-2-butenoates thereof;

of acyclic terpene aldehydes and ketones, such as, for example, geranial; neral; citronellal; 7-hydroxy-3,7-dimethyloctanal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal;

of cyclic terpene alcohols, such as, for example, menthol; isopulegol; alpha-terpineol; terpinenol-4; menthan-8-ol; menthan-1-ol; menthan-7-ol; borneol; isoborneol; linalool oxide; nopol; cedrol; ambrinol; vetiverol; guaiol; and formates, acetates, propionates, isobutyrates, butyrates, isovalerates, pentanoates, hexanoates, crotonates, tiglinates and 3-methyl-2-butenoates thereof;

of cyclic terpene aldehydes and ketones, such as, for example, menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; 2-methyl-4-(2,6,6-trimethyl-1-cyclohexen-1-yl)-2-butenal; nootkatone; dihydronootkatone; 4,6,8-megastigmatrien-3-one; alpha-sinensal; beta-sinensal; acetylated cedarwood oil (methyl cedryl ketone);

of cyclic alcohols, such as, for example, 4-tert-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;

of cycloaliphatic alcohols, such as, for example, alpha-3,3-trimethyl-cyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;

of cyclic and cycloaliphatic ethers, such as, for example, cineol; cedryl methyl ether; cyclododecyl methyl ether; 1,1-dimethoxycyclododecane; (ethoxymethoxy)cyclododecane; alpha-cedrene epoxide; 3a,6,6,9a-tetramethyldodecahydronaphtho[2,1-b]furan; 3a-ethyl-6,6,9a-trimethyldodecahydronaphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methyl propyl)-1,3-dioxane;

of cyclic and macrocyclic ketones, such as, for example, 4-tert-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone;

of cycloaliphatic aldehydes, such as, for example, 2,4-dimethyl-3-cyclohexenecarbaldehyde; 2-methyl-4-(2,2,6-trimethylcyclohexen-1-yl)-2-butenal; 4-(4-hydroxy-4-methylpentyl)-3-cyclohexenecarbaldehyde; 4-(4-methyl-3-penten-1-yl)-3-cyclohexenecarbaldehyde;

of cycloaliphatic ketones, such as, for example, 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl-2,6,10-trimethyl-2,5,9-cyclododecatrienyl ketone; tert-butyl-(2,4-dimethyl-3-cyclohexen-1-yl) ketone;

of esters of cyclic alcohols such as, for example, 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentylcyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate; 4,7-methano-3a,4,5,6,7,7a-hexahydro-5 or 6-indenyl isobutyrate; 4,7-methanooctahydro-5 or 6-indenyl acetate;

of esters of cycloaliphatic alcohols such as, for example, 1-cyclohexylethyl crotonate;

of esters of cycloaliphatic carboxylic acids, such as, for example, allyl-3-cyclohexyl propionate; allyl cyclohexyloxyacetate; cis- and trans-methyl dihydrojasmonate; cis- and trans-methyl jasmonate; methyl 2-hexyl-3-oxocyclopentanecarboxylate; ethyl-2-ethyl-6,6-dimethyl-2-cyclohexenecarboxylate; ethyl-2,3,6,6-tetramethyl-2-cyclohexenecarboxylate; ethyl-2-methyl-1,3-dioxolane-2-acetate;

of araliphatic alcohols, such as, for example, benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;

of esters of araliphatic alcohols and aliphatic carboxylic acids, such as, for example, benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate;

of araliphatic ethers, such as, for example, 2-phenylethyl methyl ether; 2-phenylethyl isoamyl ether; 2-phenylethyl-1-ethoxyethyl ether; phenylacetaldehyde dimethyl acetal; phenylacetaldehyde diethyl acetal; hydratropaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;

of aromatic and araliphatic aldehydes, such as, for example, benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl)propanal; 2-methyl-3-(4-isobutylphenyl)propanal; 3-(4-tert-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal;

of aromatic and araliphatic ketones, such as, for example, acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; 2-benzofuranyl ethanone; (3-methyl-2-benzofuranyl)ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;

of aromatic and araliphatic carboxylic acids and esters thereof, such as, for example, benzoic acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl-2,4-dihydroxy-3,6-dimethylbenzoate; ethyl-3-phenylglycidate; ethyl-3-methyl-3-phenylglycidate;

of nitrogen-containing aromatic compounds, such as, for example, 2,4,6-trinitro-1,3-dimethyl-5-tert-butylbenzene; 3,5-dinitro-2,6-dimethyl-4-tert-butylacetophenone; cinnamonitrile; 3-methyl-5-phenyl-2-pentenenitrile; 3-methyl-5-phenyl pentanenitrile; methyl anthranilate; methyl-N-methylanthranilate; Schiff bases of methyl anthranilate with 7-hydroxy-3,7-dimethyloctanal; 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; 2-(3-phenylpropyl)pyridine; indole; skatole; 2-methoxy-3-isopropylpyrazine; 2-isobutyl-3-methoxypyrazine;

of phenols, phenyl ethers and phenyl esters, such as, for example, estragole; anethole; eugenol; eugenyl methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;

of heterocyclic compounds, such as, for example, 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;

of lactones, such as, for example, 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin; octahydrocoumarin.

The amount of 4-cyclohexyl-2-butanol used in perfume oil compositions (=fragrance substance blends) is conventionally in the range from 0.01 to 99.9 wt. %, preferably 0.01 to 90 wt. %, more preferably 0.1 to 70 wt. % and particularly preferably 1 to 40 wt. %, relative to the entire perfume oil composition.

Perfume oil compositions containing 4-cyclohexyl-2-butanol are advantageously used for perfuming agents in liquid form, undiluted or diluted with a solvent. Suitable solvents for this purpose are, for example, ethanol, isopropanol, diethylene glycol monoethyl ether, glycerol, propylene glycol, 1,2-butylene glycol, dipropylene glycol, diethyl phthalate, triethyl citrate, isopropyl myristate, etc.

A further aspect of the invention concerns perfumed products containing a fragrance substance blend according to the invention. Such a perfumed product can in particular be an alcoholic perfume, a personal hygiene product or a cleaning or care product for use in the home.

The personal hygiene products can in particular be soaps, shampoos, shower gels, bath preparations, deodorants, skin creams or body lotions.

The cleaning and care products for use in the home can in particular be detergents, fabric softeners, cleaning agents and air fresheners. Regarding the use of lily of the valley fragrance substances in detergents, fabric softeners and the like, reference is made to the comments above. In this respect 4-cyclohexyl-2-butanol has proved itself to be a fragrance substance of outstanding quality.

In general terms a perfumed product according to the invention is produced by adding (a) 4-cyclohexyl-2-butanol or (b) a fragrance substance blend according to the invention (see above), optionally together with other perfume constituents, to the product (to be perfumed) such that the resulting perfumed product gives off the advantageous, in other words in particular the natural, floral and/or lily of the valley-like fragrance due to the presence of 4-cyclohexyl-2-butanol.

Accordingly, in accordance with another aspect, the present invention also concerns a process for imparting a lily of the valley fragrance or a lily of the valley fragrance note and/or for modifying an existing fragrance to make it clearer, cleaner, more transparent and fresher, wherein a sensorially effective amount of 4-cyclohexyl-2-butanol is added to a substance (an intermediate to be modified sensorially).

For some applications it is advantageous to use perfume oils containing 4-cyclohexyl-2-butanol adsorbed on a support, which ensures both a fine distribution of the fragrance substances in the product and a controlled release during use. Such supports can be porous inorganic materials such as light sulfate, silica gels, zeolites, gypsums, clays, clay granules, gas concrete, etc., or organic materials such as woods, cellulose-based substances, sugars or plastics such as PVC, polyvinyl acetates or polyurethanes.

For other applications it is advantageous to use perfume oils containing 4-cyclohexyl-2-butanol in microencapsulated or spray-dried form, as an inclusion complex or as an extrusion product and to add them in this form to the product or intermediate to be perfumed.

The properties of perfume oils modified in such a way are further optimised in some cases by coating with suitable materials with regard to a more targeted fragrance release, waxy plastics such as e.g. polyvinyl alcohol being preferably used.

Microencapsulation of the perfume oils can take place by means of the so-called coacervation process, for example, using capsule materials made from polyurethane-like substances or soft gelatine, for example. The spray-dried perfume oils can be produced by spray drying an emulsion or dispersion containing the perfume oil, for example, wherein modified starches, proteins, dextrin and vegetable gums can be used as supports. Inclusion complexes can be produced by, for example, introducing dispersions of the perfume oil and cyclodextrins or urea derivatives into a suitable solvent, e.g. water. Extrusion products can be obtained by melting the perfume oils with a suitable waxy substance and by extrusion and subsequent solidification, optionally in a suitable solvent, e.g. isopropanol.

Perfume oils containing 4-cyclohexyl-2-butanol can be used in concentrated form, in solutions or in the aforementioned modified form for the production in particular of liquid detergents, powdered detergents, laundry pretreatment agents such as bleaches, soaking agents and stain removers, fabric softeners, laundry soaps and detergent tablets (see the comments above), or of e.g. perfume extracts, eau de parfums, eau de toilettes, aftershaves, eau de colognes, preshave products, splash colognes and perfumed refreshing wipes, and for the perfuming of acid, alkaline and neutral cleaning agents, such as e.g. floor cleaners, window cleaners, washing-up liquids, bath and sanitary cleaners, scouring agent, solid and liquid WC cleaners, powdered and foaming carpet cleaners, textile fresheners, ironing aids, disinfectants, surface disinfectants and air fresheners in liquid or gel form or applied to a solid support, aerosol sprays, waxes and polishes such as furniture polishes, floor waxes, shoe creams and personal hygiene products such as e.g. solid and liquid soaps, shower gels, shampoos, shaving soaps, shaving foams, bath oils, cosmetic emulsions of the oil-in-water, water-in-oil and water-in-oil-in-water type, such as e.g. skin creams and lotions, face creams and lotions, sun creams and lotions, aftersun creams and lotions, hand creams and lotions, foot creams and lotions, depilatory creams and lotions, aftershave creams and lotions, tanning creams and lotions, haircare products such as e.g. hair sprays, hair gels, hair setting lotions, hair rinses, permanent and semi-permanent hair colorants, hair sculpting agents such as cold waves and hair smoothing agents, hair waters, hair creams and lotions, deodorants and antiperspirants such as e.g. underarm sprays, roll-ons, deodorant sticks, deodorant creams, decorative cosmetic products such as e.g. eyeshadows, nail polishes, foundations, lipsticks, mascara, and of candles, lamp oils, incense sticks, insecticides, repellents and fuels.

4-Cyclohexyl-2-butanol can be produced by methods known per se by hydrogenation of benzalacetone (4-phenyl-3-buten-2-one). The hydrogenation can conveniently be performed in one step, wherein the keto group, the double bond and the aromatic ring are hydrogenated. A suitable hydrogenating catalyst is platinum, for example (Beilsteins Handbuch der Organischen Chemie Vol. 6, 1^{st} Supplement, 4^{th} Edition 1931, p. 18; 2^{nd} Supplement, 1944, p. 38). For industrial production catalysts such as Raney nickel (Beilsteins Handbuch der Organischen Chemie Vol. 6, 3^{rd} Supplement, 1965, p. 123) and ruthenium on carbon (Houben-Weyl, Methoden der Organischen Chemie Vol. 4/1c pp. 20-21, 185) are advantageous. Commercial grades of the last-mentioned catalysts lead to excellent results, in terms of yield and sensorial quality, if the ratio by weight of catalyst used to 4-phenyl-3-buten-2-one in the hydrogenation processes is 0.001 to 0.1:1, preferably 0.005 to 0.05:1 and if during hydrogenation the hydrogen pressure is between 5 and 100 bar, preferably between 10 and 50 bar, and the temperature is between 80 and 200° C., preferably between 100 and 150° C.

The examples below illustrate the invention:

### EXAMPLE 1

### Production of 4-cyclohexyl-2-butanol

1022 g (7 mol) of benzalacetone are hydrogenated in a 2 l steel autoclave in the presence of 10 g of a ruthenium catalyst (5 wt. % Ru on activated carbon, water content of the catalyst approx. 50 wt. %) at a temperature of 130° C. and a pressure of 20 bar until hydrogen absorption has ended; the reaction time was typically around 6 to 8 hours. After removal of the catalyst by filtration, fractionation is performed using a 30 cm packed column. 995 g (91% of theoretical) of analytically and sensorially pure 4-cyclohexyl-2-butanol are obtained at a boiling point of 85° C. and at 4 mbar.

### EXAMPLE 2

### Production of a perfume oil with lily of the valley fragrance using 4-cyclohexyl-2-butanol

The following components are first mixed together:

| | Parts by |
|---|---|
| Component | weight |
| Methyl dihydrojasmonate | 60 |
| Diethyl phthalate | 71 |
| Indole | 1 |
| Geraniol | 25 |
| Phenylethyl alcohol | 50 |
| l-Citronellol | 60 |
| Hexylcinnamaldehyde | 275 |
| cis-/trans-3-Hexenyl acetate | 3 |
| Linalool | 45 |
| Linalyl acetate | 10 |
| Total: | 600 |

By the addition of 300 parts by weight of 4-cyclohexyl-2-butanol, the perfume oil composition is given a typical natural lily of the valley fragrance.

If the perfume composition thus obtained is compared with one to which an identical amount of 3-(4t-butylphenyl)-2-methyl propanal or 4-(4-hydroxy-4-methylpentyl)-3-cyclohexene carboxaldehyde (in other words an identical amount of a conventional lily of the valley fragrance substance) was added instead of the 4-cyclohexyl-2-butanol, it can be seen that with an otherwise similar fragrance impression the composition with 4-cyclohexyl-2-butanol is substantially more powerful and richer.

### EXAMPLE 3

### Production of a perfume oil with a floral fruity fragrance using 4-cyclohexyl-2-butanol

The following components are mixed together:

| | Parts by |
|---|---|
| Component | weight |
| Methyl dihydrojasmonate | 180 |
| Diethyl phthalate | 50.7 |
| beta-Damascone | 0.3 |
| Helional IFF | 15 |
| Geraniol | 60 |
| Ylang-ylang oil III | 15 |
| Phenylethyl alcohol | 90 |
| Vanillin | 10 |
| gamma-Methylionone | 15 |
| Iso E Super IFF | 225 |
| Muscone | 4 |
| Benzyl acetate | 30 |
| 1,15-Pentadecanolide | 185 |
| African bergamot oil, synth. | 60 |
| Total: | 940 |

By the addition of 60 parts by weight of 4-cyclohexyl-2-butanol the perfume oil composition is made fuller and more harmonious, the existing complex floral note is intensified and made substantially more attractive because of the additional lily of the valley aspect.

1. A method of enhancing a product fragrance by adding 4-cyclohexyl-2-butanol as a fragrance substance.

2. A method of enhancing a product fragrance by adding 4-cyclohexyl-2-butanol as a lily of the valley fragrance substance.

3. A method of enhancing a product fragrance by adding 4-cyclohexyl-2-butanol in fragrance substance compositions to obtain a clear, clean, transparent and fresh fragrance note.

4. A blend of two or more fragrance substances comprising 4-cyclohexyl-2-butanol.

5. Blend according to claim 4, containing 4-cyclohexyl-2-butanol in a quantity which
(a) modifies the olfactory properties of a blend of the other constituents of the fragrance substance blend to make it clearer, cleaner, more transparent and fresher and/or
(b) adds a lily of the valley note to the olfactory properties of a blend of the other constituents of the fragrance substance blend.

6. Blend according to claim 4, characterised in that the content of 4-cyclohexyl-2-butanol is in the range from 0.01 to 99.9 wt. %.

7. Blend according to claim 6, characterised in that the content of 4-cyclohexyl-2-butanol is in the range from 0.1 to 70 wt. %.

8. Perfumed product containing a blend according to claim 4.

9. Perfumed product according to claim 8, characterised in that said product is an alcoholic perfume, a personal hygiene product or a cleaning or care product for use in the home.

10. Process for producing a perfumed product according to claim 9, characterised in that 4-cyclohexyl-2-butanol is added to the product such that the perfumed product gives off a natural, floral and/or lily of the valley-like fragrance due to the presence of 4-cyclohexyl-2-butanol.

11. Process for imparting a lily of the valley fragrance and/or a lily of the valley fragrance note or for modifying an existing fragrance to make it clearer, cleaner, more transparent and fresher, wherein a sensorially effective amount of 4-cyclohexyl-2-butanol is added to a substance.
